(19) United States
(12) Patent Application Publication
(10) Pub. No.: US 2018/0146771 A1
(43) Pub. Date: May 31, 2018

(54) HEAD-MOUNTABLE VIEWER

(71) Applicant: UNOFFICIAL CARDBOARD, INC., Deerfield, IL (US)

(72) Inventor: David Jess Vinzant, Murrieta, CA (US)

(21) Appl. No.: 15/365,562

(22) Filed: Nov. 30, 2016

(51) Int. Cl. A45F 5/00; F16M 13/04

(52) U.S. Cl. CPC A45F 5/00; F16M 13/04

(57) ABSTRACT

Disclosed herein is a head-mountable viewer that includes a strap and tab that are positioned on the head-mountable viewer to provide a more reliable method of securing computing device within a cavity of the head-mountable viewer. In addition, the head-mountable viewer is manufactured to include various creases throughout, which thereby allows the head-mountable viewer to be manufactured in a way to reduce costs, such as by being able to manufacture the head-mountable viewer in a packaging form. The user is then able to easily follow simple instructions to change the head-mountable viewer from its packaging form to a usable form. In addition, the various creases of the head-mountable viewer provides a unique method to block sunlight and external noise from the eyes of the user via extension pieces.

### BACKGROUND

Head-mountable viewers take on many shapes and forms to allow users to view and take part in virtual reality. In this regard, head-mountable viewers can be designed and configured in many different ways. For example, various head-mountable viewers may implement different methods to orient or otherwise install a computing device within the head-mountable viewer. In addition, the head-mountable viewer itself may be designed differently in terms of how sunlight and other external noise is blocked from a user's periphery vision, in order to provide the most comprehensive and enjoyable experience to the user.

Furthermore, designing the head-mountable viewer in a manner that allows for mass production at a reduced budget is beneficial to companies to increase profit margins. For example, many companies in addition to head-mountable viewer manufacturers may design a product and also a packaging for the product. Thus, the requirement to develop adequate and aesthetically appealing packaging for a product may reduce profits for the respective company, and the ability to save costs with respect to packaging the product may increase the company's bottom line.

### SUMMARY

A head-mountable viewer that is designed to efficiently and effectively operate is disclosed herein. For example, the present disclosure discloses a head-mountable viewer implements strap and tab to secure a computing device within a cavity of the head-mountable viewer and a method to manufacture a head-mountable viewer with extensions to block external noise. Furthermore, the head-mountable viewer disclosed herein combines a frame of the head-mountable viewer with a packaging thereof to provide a more cost-effective and efficient manner to transport the head-mountable viewer.

A head-mountable viewer is disclosed herein, and the head-mountable viewer includes a frame that includes a cavity; and a door positioned adjacent to the cavity, the door configured to close the cavity in a closed position and open the cavity in an opened position; a tab positioned on an outside portion of the frame; and a strap attached to the door.

As a further example, the when the door of the head-mountable viewer is in a closed position the strap attaches to the tab, thereby securely closing the door against the frame. In another example, the frame further includes a top end; a bottom end opposite the top end; a first side end; a second side end opposite the first side end; and a front end, wherein the front end is positioned opposite the door when the door is in the closed position. As another embodiment, the tab is positioned on the top end of the frame. In another example, the frame includes a crease, the crease positioned on a portion of the bottom end, wherein the door moves between the opened and closed position about the crease. As a further example, a portion of the strap on an outside portion of the door is positioned opposite a side of the crease. Furthermore, the tab includes at least one notch configured to receive at least a portion of the strap. In a further example, the strap extends from the bottom end of the frame to an upper portion of an inside of the door and to an outside of the door. In another example, the strap extends through a plurality of holes on the frame. As another example, the strap is an elastic band. Moreover, the frame includes a plurality of holes that the strap extends through; and the strap has a first end and a second end, both ends being attached to an anchor that prohibits the first and second ends from falling through the holes.

As another embodiment, a head-mountable viewer is disclosed herein, which includes a frame having a cavity therein, the frame including a front side and a rear side, the rear side is opposite the front side; a left flap configured to open and close a left portion of the cavity, wherein in the closed position the left flap removably attaches to the frame to at least partially cover the right portion of the cavity; a right flap opposite the left flap, the right flap configured to open and close a right portion of the cavity, wherein in the closed position the right flap removably attaches to the frame to at least partially cover the right portion of the cavity; a left extension that overlaps with the left flap, wherein the left extension extends beyond the frame toward the front side of the frame; a right extension that overlaps with the right flap, wherein the right extension extends beyond the frame toward the front side of the frame.

As a further example, the left flap and the right flap of the head-mountable viewer bend about a left and right flap crease, respectively, the respective left and right flap creases causing the left and right flaps to bend in a vertical direction. In another example, the left and right extensions bend about a left and right extension crease, the respective left and right extension creases causing the left and right extensions to bend in a horizontal direction toward the front side of the frame. Furthermore, the left and right flaps overlap with the left and right extensions, respectively, such that the left and right flaps are positioned on top of the left and right extensions.

### BRIEF DESCRIPTION OF THE DRAWINGS

FIGS. 1A-B illustrate a front side and a back side of a head-mountable viewer in package form in accordance with aspects of the disclosure.

FIGS. 2A-C shows the perforated edges of the front side of the packaging of the head-mountable viewer being disassembled in accordance with aspects of the disclosure.

FIGS. 3A-B illustrate a first and second side of the folded frame of the head-mountable viewer in accordance with the disclosure.

FIG. 4 depicts the frame of the head-mountable viewer with extensions and flaps extended in accordance with aspects of the disclosure.

FIGS. 5A-B illustrates a front and back side of the head-mountable viewer in box form in accordance with aspects of the disclosure.

FIG. 6A illustrates a left flap overlapping a left extension and removably attaching to the frame in accordance with aspects of the disclosure.

FIG. 6B illustrates the left and right extensions secured to the frame and extending toward a front side of the frame in accordance with aspects of the disclosure.

FIGS. 7A-G are various views of a strap and a tab that the strap secures to in accordance with aspects of the disclosure.

FIG. 8 illustrates lenses within a casing in accordance with aspects of the disclosure.

### DETAILED DESCRIPTION

The aspects, features and advantages of the present disclosure will be appreciated when considered with reference to the following description of preferred embodiments and accompanying figures. The following description does not limit the disclosure; rather, the scope is defined by the appended claims and equivalents. While certain processes in accordance with example embodiments are shown in the figures as occurring in a linear fashion, this is not a requirement unless expressly stated herein. Different processes may be performed in a different order or concurrently.

The present disclosure describes a head-mountable viewer that employs a strap to securely attach a door of a frame of the head-mountable viewer to the frame. The head-mountable viewer further includes a left side extension and a right side extension that are secured in place by a left and right flap, and the left and right side extensions extend toward a front side of the frame to block light and other external influences and noise during the user experience. Furthermore, the frame of the head-mountable viewer is not only used for the virtual experience reality, that is, the product itself, but the frame also serves as at least a portion of the packaging in transporting the head-mountable viewer.

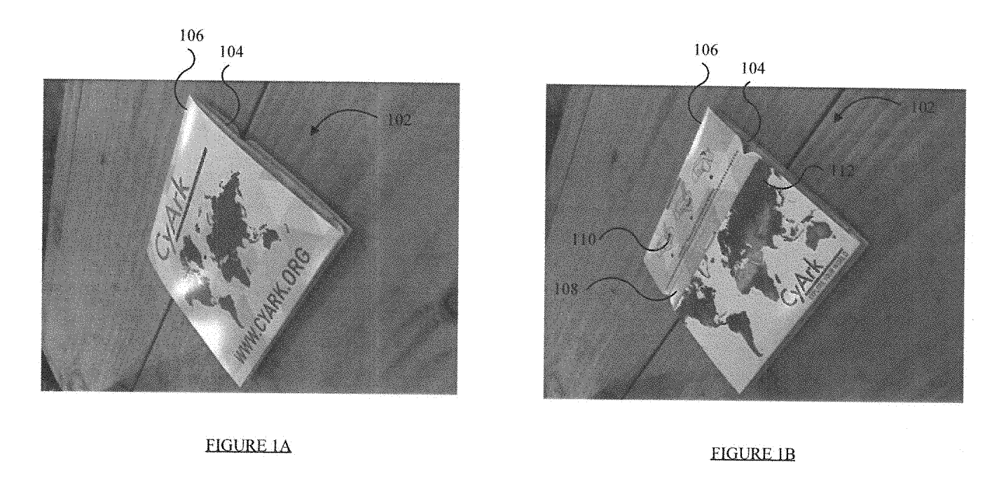

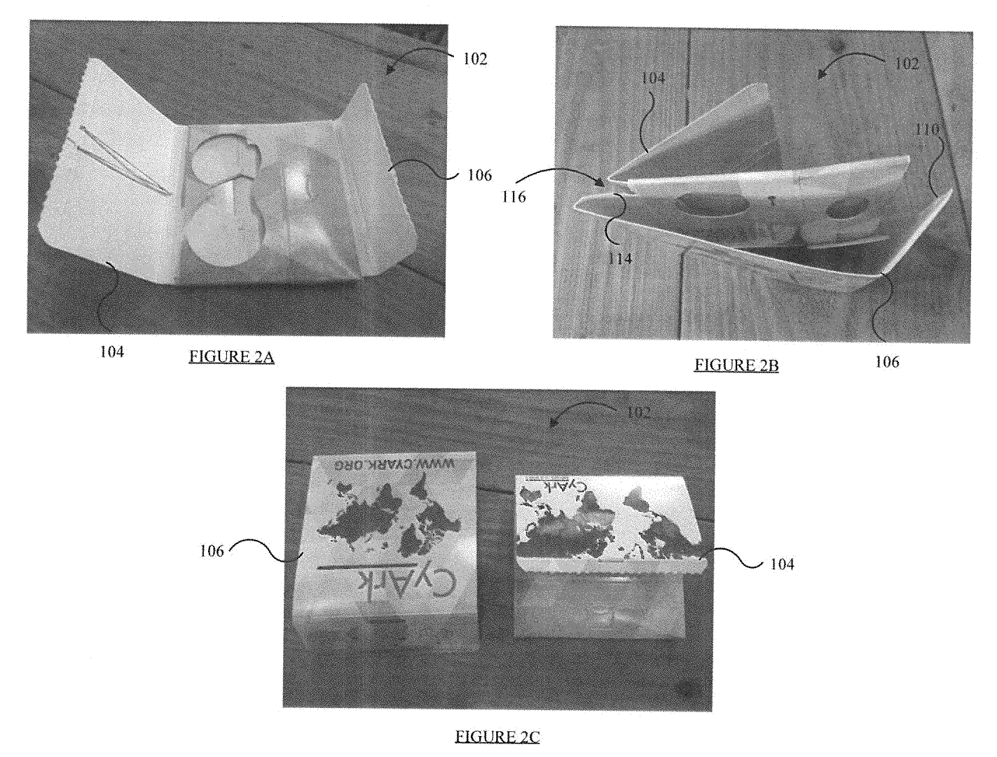

As depicted in FIGS. 1A-B, a head-mountable viewer is folded and configured in a manner such that a frame 104 of the head-mountable viewer itself also acts as a packaging, such as package 102. The various components of the head-mountable viewer, frame 104 and package 102 may be cardboard, plastic, or similar type of material that can function as disclosed herein. In this regard and as discussed in further detail below, when the frame 104 is unfolded the frame 104 will take the shape of a head-mountable viewer. At this stage, however, the frame 104 is folded and creased in a manner to make the head-mountable viewer conducive to being an easily transportable package. The package 102 includes the frame 104 in packaged form along with an outer shell 106, which is removably attached with the frame 104. FIG. 1A shows a first side of the package 102 with the folded frame 104 and the outer shell 106 and FIG. 1B shows a second side of the package 102 with the folded frame 104 and the outer shell 106 as the package 102. As illustrated in FIG. 1B, the package 102 includes a perforated edge 108 that can be torn thereon, in order to separate the two opposing ends of the perforated edge 108. The first perforated end 110 is part of the outer shell 106 and the second perforated end 112 is part of the frame 104.

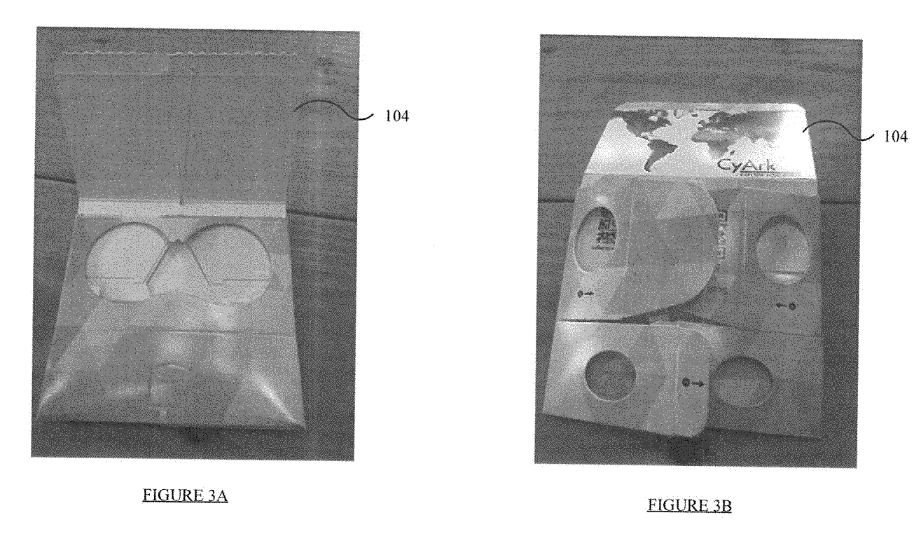

FIG. 2A illustrates the package 102 in an opened position after the perforated edges 108 have been torn apart and the first perforated end 110 and the second perforated end 112 are now detached and separated. The first perforated end 110 is part of the external shell 106, and the second perforated end 112 is a part of the frame 104. In this regard, the portion of the frame 104 that the second perforated end 112 is a part of acts as at least a portion of the packaging of the package 102. Further and as discussed in further detail below, the frame 104 will form a part of the head-mountable viewer when the frame 104 is unfolded and configured accordingly. Folding the frame 104 of the head-mountable viewer to form part of the package may save expense and cost when manufacturing the head-mountable viewer, in that a manufacturer of the head-mountable viewer does not need to manufacture an entire separate component to wrap and package the head-mountable viewer. Rather, as disclosed herein the head-mountable viewer simply employs an easy to manufacture outside shell 106 that is removably attached to and manufactured with a portion of the frame 104 of the head-mountable viewer itself. In addition, the head-mountable viewer includes a series of creases and is folded accordingly to package the head-mountable viewer. These processes and techniques at least save costs and time when manufacturing and transporting the head-mountable viewer. In addition, this allows the seller to save on postage costs, the compactness allows for less space to be taken up on the shelves of retailers, and makes the overall product easier for user's to pick up.

As shown in FIG. 2B, the external shell 106 includes a folded end 114, which is opposite the first perforated end 110, which is tucked securely into an opening 116 of the frame 104. The folded end 114 is removed from the opening 116 when the user opens the package 102 and seeks to unfold the head-mountable viewer into usable form. Therefore, the external shell 106 is secured to the frame 104, and thereby forms the package, by having the first end 110 removably attached to the frame 104 via the perforated edges 108, and the folded end 114 is securely attached to the frame 104 by being folded and tucked within the opening 116 thereof, thereby comprising a single secure and transportable unit, as depicted in FIGS. 1A-B. FIG. 2C shows the external shell 106 adjacent to the frame 104 when the two pieces are completely separated. Furthermore, it should be understood that although the perforated edges 108 are used to attach the first perforated end 110 to the second perforated end 112, other mechanisms are also available, such as tape, glue, Velcro™, etc. In addition, the folded end 114 of the external shell 110 may also be attached to the frame 104 via other attachment mechanisms other than being tucked within the opening 116, such as Velcro™, glue, tape, etc.

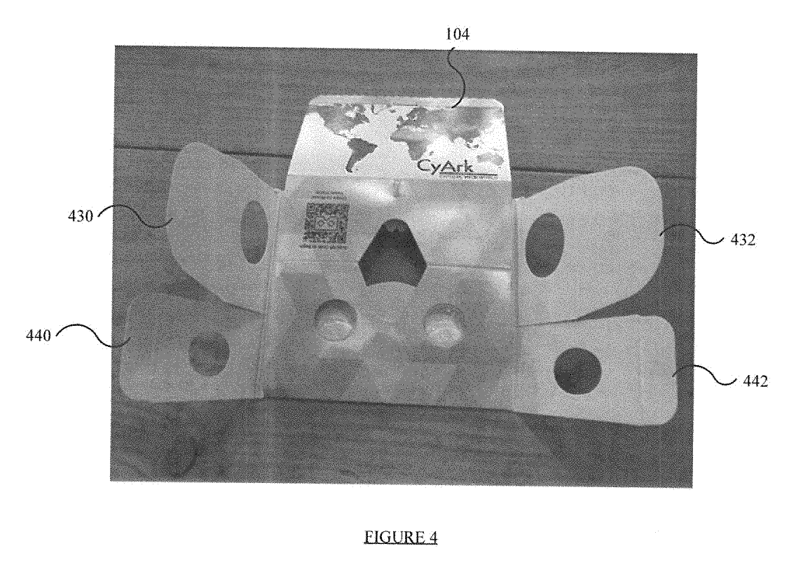

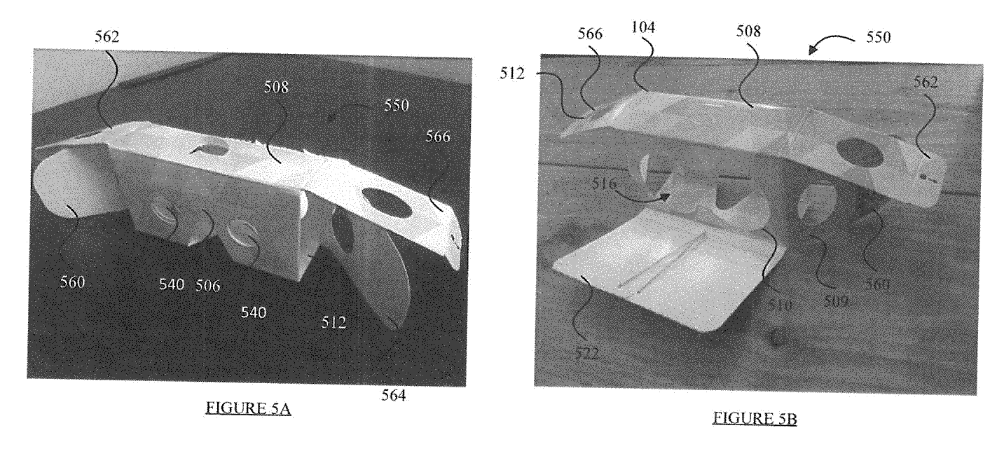

The frame 104 is now ready to be adapted from the packaging form to a usable head-mountable viewer. FIGS. 3A-B show two opposite sides of the frame 104 with the external shell 106 no longer attached thereto. FIG. 4 then shows the transition from the side of FIG. 3A, where the first and second side arm 430, 432 and first and second tabs 440, 442 are spread outward. The first and second side arms 430, 432 and the first and second tabs 440, 442 may be spread outward when a user begins unraveling the frame 104 from the packaged form. By pulling outward the two side arms and the two tabs, the body of the frame 104 is left in the center for the user to pop-out and take the shape and form of a usable head-mountable viewer.

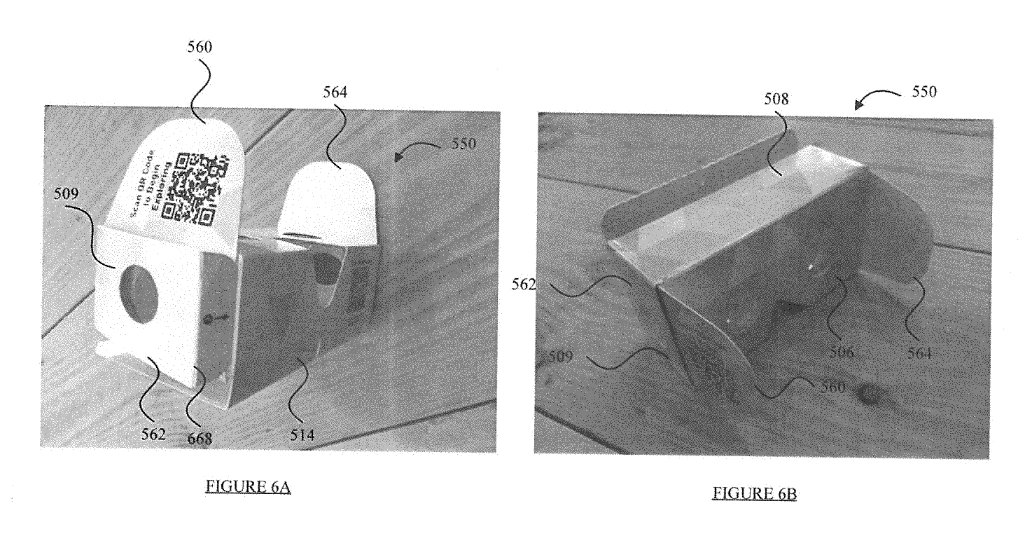

For instance, FIGS. 5A-B depict the frame 104 of FIG. 4, but has now been popped out and is no longer flattened in the packaging form. Rather, the frame 104 is beginning to take the shape of a wearable and usable device. Specifically, the frame 104 is beginning to form a box-like shape. In this regard, the device may now be considered a head-mountable viewer 550.

The head-mountable viewer 550 includes the frame 104 which has a plurality of sides. For example, the frame 104 includes a front side 506, top side 508, left side 509, rear side 510, right side 512, and bottom side 514 (not shown). The rear side 510 includes a door 522 to provide access to a cavity 516 of the head-mountable viewer 550. In this regard, a computing device, such as a Smartphone, may be placed within the cavity 516 of the head-mountable viewer 550. The front side 506 includes two openings with lenses 540 therein for eyes of a user to see a display of the computing device positioned within the cavity 516. In addition, the front side 506 includes one opening for a nose of the user, which allows for the head-mountable viewer to be comfortably snug against a face of the user.

The head-mountable viewer 550 includes a left extension 560 and a left flap 562 positioned on the left side 509, and also a right extension 564 and a right flap 566 positioned on the right side 512. The left and right extensions 560, 564 are implemented to provide additional shade by blocking light on a periphery of the eyes of the user when using the head-mountable viewer 550. In this regard and with reference to FIGS. 6A-B, the left and right extensions 560, 564 bend about a crease, such as crease 668 on the left extension 560, and the left and right extensions 560, 564 bend in a horizontal direction toward and beyond the front side 506. From here, the left and right flaps 562, 566 bend about their respective creases in a downward vertical manner, and overlaps the left and right extensions 560, 564, respectively. Therefore, the left and right flaps 562, 566 are positioned on top of the left and right extensions 560, 564, respectively, and thereby secure the extensions in place.

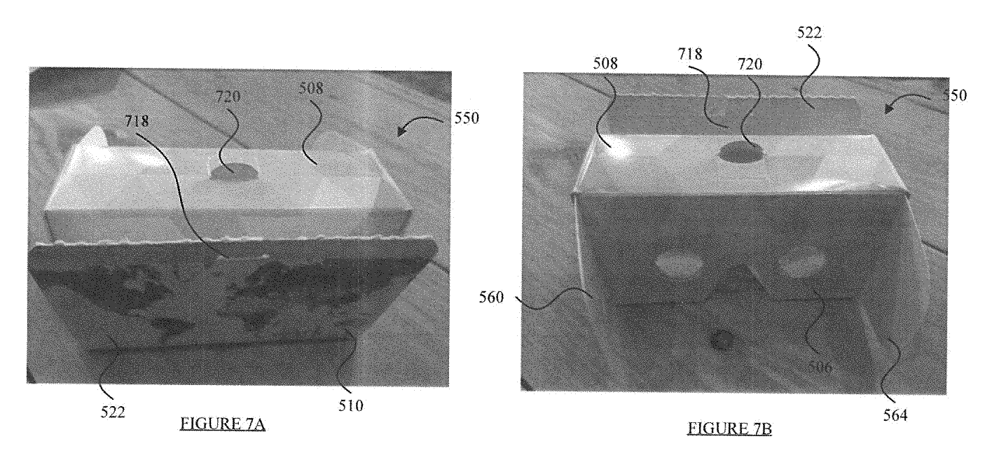

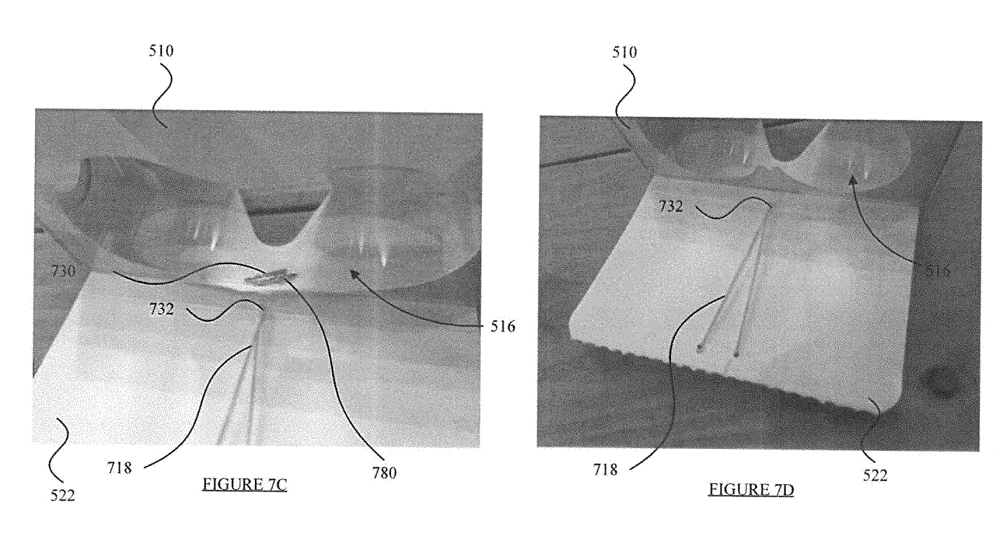

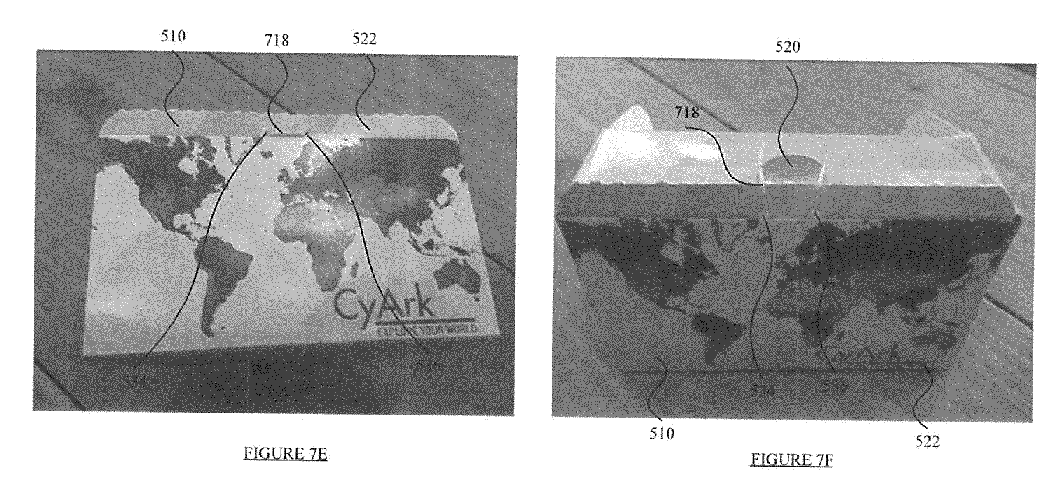

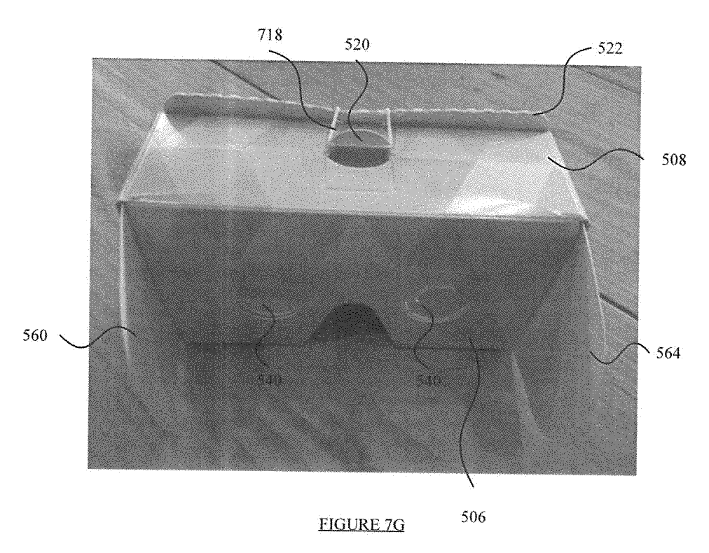

Referring now to FIGS. 7A-G, the rear side 510 includes a door 522 that opens and closes access to the cavity 516 of the frame 104. The door 522 is positioned on the rear side 510. The door 522 includes a strap 718 that attaches to a tab 720, the tab being positioned on the top side 508 as shown in FIGS. 7A-B.

The strap 718 may be an elastic band that is capable of stretching to wrap around and thereby secure itself to the tab 720. The strap 718 includes a length and pierces through various holes throughout the frame 104 in order to securely affix to the tab 720 and thereby securely close the door 522 against the frame 104. For example, as shown in FIG. 7C the bottom side 514 includes a first hole 730 that the strap 718 extends through. The strap 718 includes two anchors 780 on respective ends thereof that prohibit the strap 718 from completely extending through the first hole 730 or any hole on the frame 104, and thereby allowing the strap 118 to stay in a tight position.

As shown in FIGS. 7C-D the strap extends from an inside portion of the bottom side 514 to an outside portion of the bottom side 514, the inside portion of the bottom side being the same side as the cavity and the outside portion being the opposite of the inside portion. From there, the strap 718 extends through a second hole 732 positioned on the bottom side 514 and adjacent to the first hole 730, and the strap extends to an inside portion of the door 522. It should be understood that the second hole 732 may be positioned on the bottom side 514, the door 522, or in between the two, such as on a crease of the door 522. As shown in FIG. 7D the strap 718 then travels across one end of the door 522 to an opposite end of the door 522. The strap 718 then extends through a third and fourth hole 534, 536 that are positioned opposite the second hole 732 on an upper portion of the door 522, as depicted in FIGS. 7D-E. The strap 718 extends through the third and fourth holes 534, 536, which completes the path of the strap 718. Finally, as shown in FIGS. 7F-G, the strap 718 may be grabbed or otherwise manipulated by the user to be positioned around the tab 720.

The tab 720 may be a part of the frame 104 itself, such that the frame 104 is partially cut-out so that the tab 720 is able to prop upward away from and on an exterior of the frame 104. In this way, the user is able to prop the tab 720 upward such that the strap can be positioned around the tab 720. In addition, the tab 720 may include notches or cut-outs that correspond to an external diameter of the strap 718, so that the strap 718 is able to be positioned within the notch or cut-out. This may improve the ease of the user being able to position the strap 718 around the tab 720, while also prohibiting the strap 718 from easily falling off of the tab 720.

As another example, the tab 720 may be a separate piece that is attached to the frame 104. For example, the tab 720 may be attached to the frame 104 via glue, staple, Velcro™ or other connecting mechanism.

As a further example, the tab 720 may include additional reinforcement material on at least a portion thereof in portions where the strap 718 wraps around the tab 720, such as where the notches or cut-outs are located. The reinforcement material may protect the tab 720 from damage after the repeated use of the strap 718 grasping around the tab 720. The reinforcement material may be additional material of the frame 104, an insert, such as rubber, metal, plastic, etc. that latches onto the tab 720 itself, such as slides onto the ends thereof or over the entire tab 104. The tab 104 may also be other shapes or in addition to that depicted in the figures, such as a triangle, rectangle, square etc., or the tab 104 may form the shape of an actual object, such as a car, person, emoji, etc.

Prior to securing the strap 718 to the tab 720, the user may place his or her computing device within the cavity 516 of the head-mountable viewer 550. By way of example only, the computing device may be a Smartphone or other computing device that includes a processor, memory, display, and other components typically associated with a computing device. The computing device may be placed within the cavity 516 such that the display thereof faces toward the front side 506 so that the user may view the display through the lenses 540.

When the computing device is properly placed within the cavity 516 and the user secures the door 522 via the strap 718 and tab 720, the user may place the front side 506 of the head-mountable viewer 550 in front of his or her eyes. The left and right extensions 560, 564 are positioned adjacent to the eyes of the user to help block exterior noise, including sunlight, artificial light, people, objects, and other distractions.

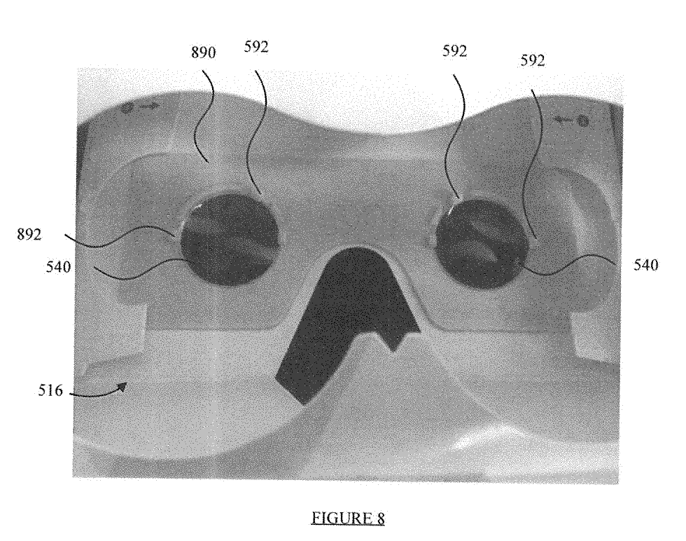

As a further embodiment and with reference to FIG. 8, the head-mountable viewer may implement a casing 890 for the lenses 540. The lenses 540 may be secured within the openings of the casing 890 via a tab and notch mechanism, friction fit, etc. The casing 890 includes notches 892 that help secure the lenses 540 in place. The casing 890 is positioned within the cavity 516 and attached to the head-mountable viewer 550 such that the corresponding openings on the head-mountable viewer 550 align with the openings and lenses of the casing 890. The casing may be attached to the head-mountable viewer via glue, tape, staples, clips, or other attachment mechanism. The configuration and implementation of the casing 890 for the lens 430 makes it easy to insert the lens and difficult to remove them. In this regard, the casing 890 allows for the device to be safer for children and toddlers such that the lens, which may be manufactured of plastic or glass, cannot easily be removed, thereby reducing the possibility of the child injuring himself, herself, or a third party.

As an alternative embodiment, the outer shell 106 may be completely part of the head-mountable viewer 104. For example, instead of the outer shell 106 only partially being part of the head-mountable viewer and being torn away via perforated edges 108, the frame 104 may be configured such that the entire outer shell 106 is part of the frame 104. In this regard, the entire frame 104 of the head-mountable viewer is also the product packaging.

As another embodiment, the strap 118 may include just a single anchor that is connected to both ends of the strap 118. For example, instead of each end of the strap 118 including its own anchor, only a single anchor may be implemented that is attached to both ends of the strap 118.

As a further embodiment, the various pieces of the head-mountable viewer may include numeral indicators to provide helpful instructions to the user when assembling the head-mountable viewer. For example, the one or more components that should be manipulated first may have a number one thereon so that the user knows that particular component should be manipulated first. Further numerals, such as two, three, etc., may be placed on the various components that should be manipulated by the user in the appropriate order. For example, the outer shell may have a number one thereon so the user knows to take the outer shell off first before doing anything else. After that, a number two may be placed on the extensions so the user knows to manipulate the extensions toward the front side of the head-mountable viewer. Finally, the flaps may include a number three so the user knows that they can lock the extensions in place by locking in the flaps with the frame. In addition, arrows may accompany the numbers or be used as an alternative so the user knows which direction to manipulate the various components.

Advantages of the present disclosure include the ability to more reliably secure a computing device within the head-mountable viewer via the strap and tab. The implementation of the strap and the tab allow for a secure, reliable, and fortuitous method to secure the computing device within the head-mountable viewer. The strap and tab are sufficiently strong structures that cannot easily break or rip, and accordingly should last long-term for the user.

Furthermore, the implementation of the flaps to lock the extensions in place allows the user to easily configure the head-mountable viewer to block light and other external noise.

The various creases and bending locations positioned throughout the head-mountable viewer also allows for the head-mountable viewer to be shipped in a flattened state, such as shown in FIGS. 1A-B, which may also reduce shipping costs, storage costs, etc. Finally, the various creases and configuration of the head-mountable viewer allow for a portion of the head-mountable viewer itself to act as its own packaging, thereby also reduce costs by reducing the cost to manufacture or pay for shipping, such as costing less money on postage. In addition, the product takes up less space for retailers and the item is easier to pick up by the user.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A head-mountable viewer, comprising:
a frame including:
a cavity; and
a door positioned adjacent to the cavity, the door configured to close the cavity in a closed position and open the cavity in an opened position;
a tab positioned on an outside portion of the frame; and
a strap attached to the door.

2. The head-mountable viewer of claim 1, wherein when the door is in a closed position the strap attaches to the tab, thereby securely closing the door against the frame.

3. The head-mountable viewer of claim 1, wherein the frame further comprises:
a top end;
a bottom end opposite the top end;
a first side end;
a second side end opposite the first side end; and
a front end, wherein the front end is positioned opposite the door when the door is in the closed position.

4. The head-mountable viewer of claim 3, wherein the tab is positioned on the top end of the frame.

5. The head-mountable viewer of claim 4, wherein the frame includes a crease, the crease positioned on a portion of the bottom end, wherein the door moves between the opened and closed position about the crease.

6. The head-mountable viewer of claim 5, wherein a portion of the strap on an outside portion of the door is positioned opposite a side of the crease.

7. The head-mountable viewer of claim 1, wherein the tab includes at least one notch configured to receive at least a portion of the strap.

8. The head-mountable viewer of claim 3, wherein the strap extends from the bottom end of the frame to an upper portion of an inside of the door and to an outside of the door.

9. The head-mountable viewer of claim 1, wherein the strap extends through a plurality of holes on the frame.

10. The head-mountable viewer of claim 1, wherein the strap is an elastic band.

11. The head-mountable viewer of claim 1, wherein:
the frame includes a plurality of holes that the strap extends through; and
the strap has a first end and a second end, both ends being attached to an anchor that prohibits the first and second ends from falling through the holes.

12. A head-mountable viewer, comprising:
a frame having a cavity therein, the frame including a front side and a rear side, the rear side is opposite the front side;
a left flap configured to open and close a left portion of the cavity, wherein in the closed position the left flap removably attaches to the frame to at least partially cover the right portion of the cavity;
a right flap opposite the left flap, the right flap configured to open and close a right portion of the cavity, wherein in the closed position the right flap removably attaches to the frame to at least partially cover the right portion of the cavity;
a left extension that overlaps with the left flap, wherein the left extension extends beyond the frame toward the front side of the frame;
a right extension that overlaps with the right flap, wherein the right extension extends beyond the frame toward the front side of the frame.

13. The head-mountable viewer of claim 12, wherein the left flap and the right flap bend about a left and right flap crease, respectively, the respective left and right flap creases causing the left and right flaps to bend in a vertical direction.

14. The head-mountable viewer of claim 13, wherein the left and right extensions bend about a left and right extension crease, the respective left and right extension creases causing the left and right extensions to bend in a horizontal direction toward the front side of the frame.

15. The head-mountable viewer of claim 14, wherein the left and right flaps overlap with the left and right extensions, respectively, such that the left and right flaps are positioned on top of the left and right extensions.
